(19) United States
(12) Patent Application Publication
(10) Pub. No.: US 2026/0126958 A1
(43) Pub. Date: May 7, 2026

(54) ELECTRONIC DEVICE AND AUDIO SIGNAL LINK DESIGN METHOD

(71) Applicant: Tymphany HK Limited, Wanchai (HK)

(72) Inventors: Chi-An YOUNG, Taipei City (TW); Ryan Meng-Wei LU, Taipei City (TW)

(21) Appl. No.: 19/213,398

(22) Filed: May 20, 2025

Related U.S. Application Data
(60) Provisional application No. 63/715,026, filed on Nov. 1, 2024.

(51) Int. Cl. G06F 8/20; G06F 3/16

(52) U.S. Cl. CPC G06F 8/20; G06F 3/165

(57) ABSTRACT

An audio signal link design method includes obtaining, through a user interface, an application information and a prompt; generating, based on the application information and the prompt, an audio link archive using a generative AI algorithm; and automatically loading and executing the audio link archive by a process design software. An electronic device includes a storage module, for storing an audio link generation program and a processing module, electrically connected to the storage module, for reading the audio link generation program for executing the audio signal link design method.

### CROSS REFERENCE TO RELATED APPLICATIONS

This application claims priority of U.S. Provisional Application No. 63/715,026 filed on Nov. 1, 2024 under 35 U.S.C. § 119(e), the entire contents of all of which are hereby incorporated by reference.

### BACKGROUND

### Technical Field

The present disclosure relates to an electronic device and a link design method. More specifically, the present disclosure relates to an electronic device and an audio signal link design method.

### Related Art

In order to make audio electronic products have the best acoustic performance, an important part of an audio electronic product design is the optimization of audio signal processing. Generally, developers may use existing audio link editing software to perform an audio processing optimization design. The existing audio link editing software is often presented in the form of a visual programming language to simplify the program editing.

However, the current editing method still requires developers to manually drag objects or establish relationships between objects, and the design parameters of the objects still need to be input manually by the developers. In addition, in order to achieve the best audio effect, the objects generally need to be carefully adjusted so that an audio link may achieve a desired acoustic performance. In this way, the design of audio processing optimization is time-consuming and the complexity of an audio link design is increased.

### SUMMARY

The present disclosure relates to an audio signal link design method including the steps of obtaining an application information and a prompt through a user interface; generating, based on the application information and the prompt, an audio link archive using a generative AI algorithm; and automatically loading and executing the audio link archive by a process design software.

In an embodiment, the audio signal link design method includes the steps of obtaining an optimized prompt; generating, based on the application information, the prompt and the optimized prompt, an optimized audio link archive using the generative AI algorithm; and automatically loading and executing the optimized audio link archive by the process design software.

In an embodiment, the generative AI algorithm is a large language model.

In an embodiment, the generative AI algorithm generates the audio link archive by a retrieving augmented generation model.

In an embodiment, the prompt is a language text.

In an embodiment, the application information is a preset application option.

In an embodiment, the audio link archive includes a metadata of the process design software.

The present disclosure further relates to an electronic device including a storage module and a processing module. The storage module is used to store an audio link generation program. The processing module is electrically connected to the storage module. The processing module is used to read the audio link generation program for executing the audio signal link design method mentioned above.

According to the above, the electronic device and the audio signal design methodology of the present disclosure may generate the audio link archive using the generative AI algorithm based on the application information and the prompt and then may automatically load and execute the audio link archive using the process design software. Thus, developers do not need to manually drag objects or establish relationships between objects, nor do they need to manually enter the design parameters of objects. The developers may use the electronic device and audio signal link design method of the present disclosure to quickly generate an audio link archive that may be executed by a process design software. Thus, the time and complexity of designing an audio link is effectively reduced.

It should be understood, however, that this summary may not contain all aspects and embodiments of the present invention, that this summary is not meant to be limiting or restrictive in any manner, and that the invention as disclosed herein will be understood by one of ordinary skill in the art to encompass obvious improvements and modifications thereto.

### BRIEF DESCRIPTION OF THE DRAWINGS

The features of the exemplary embodiments believed to be novel and the elements and/or the steps characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows, taken in conjunction with the accompanying drawings in which:

FIG. 1 is a schematic of a user interface according to an embodiment of the present disclosure.

FIG. 2 is a schematic of a user interface according to another embodiment of the present disclosure.

FIG. 3 is a schematic of a display image of a process design software according to an embodiment of the present disclosure.

FIG. 4 is a schematic of an electronic device according to an embodiment of the present disclosure.

FIG. 5 is a schematic of an audio signal design method according to an embodiment of the present disclosure.

FIG. 6 is a schematic of an audio signal design method according to another embodiment of the present disclosure.

### DETAILED DESCRIPTION OF THE EMBODIMENTS

The present invention will now be described more fully hereinafter with reference to the accompanying drawings, in which exemplary embodiments of the invention are shown. The present invention may, however, be embodied in many different forms and should not be construed as limited to the embodiments set forth herein. Rather, these embodiments are provided so that the present invention will be thorough and complete, and will fully convey the scope of the present invention to those skilled in the art.

Certain terms are used throughout the description and following claims to refer to particular components. As one skilled in the art will appreciate, manufacturers may refer to a component by different names. This document does not intend to distinguish between components that differ in name but not in function. In the following description and in the claims, the terms “include/including” and “comprise/comprising” are used in an open-ended fashion, and thus should be interpreted as “including but not limited to”. “Substantial/substantially” means, within an acceptable error range, the person skilled in the art may solve the technical problem in a certain error range to achieve the basic technical effect.

The following description is of the best-contemplated mode of carrying out the invention. This description is made for the purpose of illustration of the general principles of the invention and should not be taken in a limiting sense. The scope of the invention is best determined by reference to the appended claims.

Moreover, the terms “include”, “contain”, and any variation thereof are intended to cover a non-exclusive inclusion. Therefore, a process, method, object, or device that comprises a series of elements not only includes these elements but also comprises other elements not specified expressly, or may include inherent elements of the process, method, object, or device. If no more limitations are made, an element limited by “include a/an . . . ” does not exclude other same elements existing in the process, the method, the article, or the device which comprises the element.

In the following embodiments, the same reference numerals are used to refer to the same or similar elements throughout the invention.

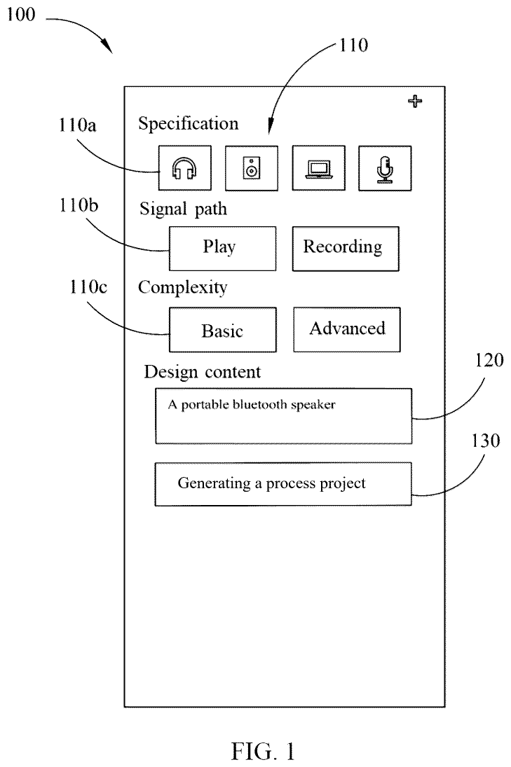

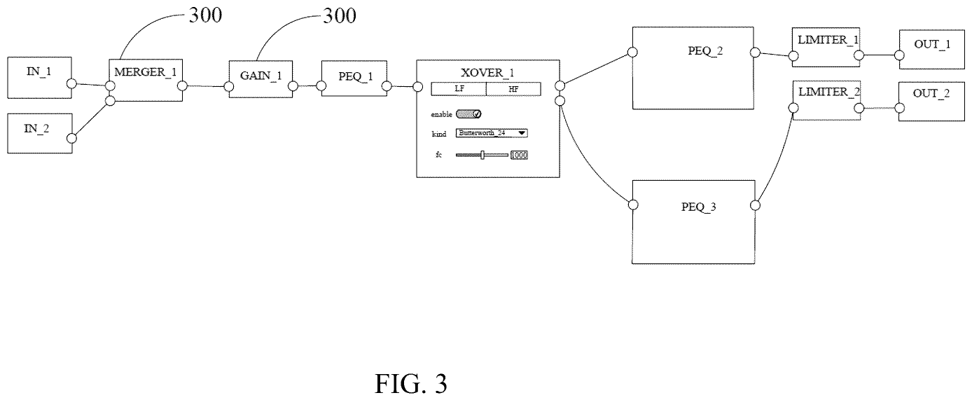

FIG. 1 is a schematic of a user interface according to an embodiment of the present disclosure. The user interface 100 includes at least one preset application option 110, a prompt input block 120, and a process project generating object 130. The application option 110 is used to indicate different audio link design requirements. For example, the application option 110 of the embodiment of the present disclosure may be used to indicate a specification of the electronic device applied by an audio link, an audio signal path of the audio link, and a complexity of an audio link design. A user may input design requirements of the audio link by selecting the at least one application option 110. For example, when the user selects the application options 110 of an earphone 110a, a play 110b and a basic 110c, it means that the design requirement of the audio link is an audio link played with an earphone, and the complexity of the audio link design is basic. The prompt input block 120 is a prompt input area. The user may enter a prompt in the prompt input block 120. The prompt is language text typed by the user in natural language. Through the prompt input block 120, the user may further simply and quickly input the design requirements of the audio link through the prompt. The process project generating object 130 is used to receive a process project generating request from a user. After the user inputs the design requirements of the audio link through the application option 110 and the prompt input block 120 of the user interface 100, the user may select the process project generating object 130 to input the process project generating request. After the process project generating request is inputted, the audio link archive is generated by a generative AI algorithm based on the application information corresponding to the application options 110 selected by the user and the prompt (e.g., a language text of “a portable Bluetooth speaker”) inputted through the prompt input block 120. The audio link archive is then automatically loaded and executed by a process design software. As shown in FIG. 3, the audio link archive may be loaded and executed by a process design software (e.g., Flow Studio) and presented by objects 300 of the process design software. Connections are established between the objects 300, and parameter settings of the objects 300 are completed. Therefore, the user does not need to manually drag the objects 300 or establish the relationship between the objects 300, nor does the user need to manually input the design parameters of the objects 300, and the audio link archive may quickly be generated and executed. Thus, the time and complexity of the audio link design is effectively reduced.

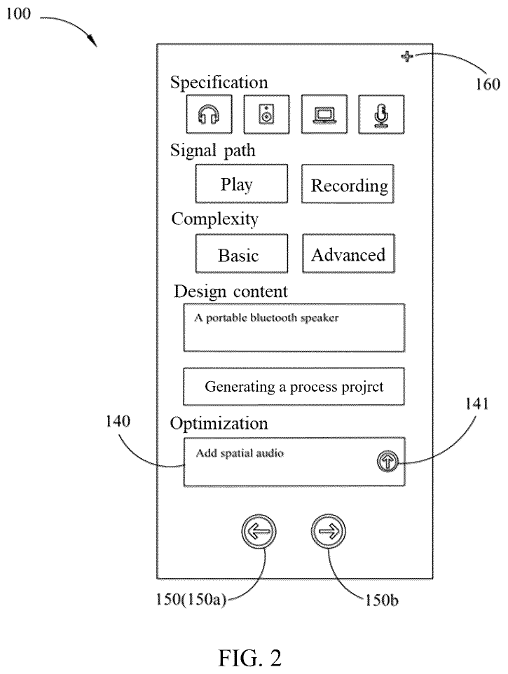

FIG. 2 is a schematic of a user interface according to another embodiment of the present disclosure. After the user generates the audio link archive through the user interface 100 for the first time, the user interface 100 switches to include an optimized prompt input block 140 and a process project option 150. The optimized prompt input block 140 is an optimized prompt input area. The user may input an optimized prompt in the optimized prompt input block 140. The optimized prompt is language text typed by the user in natural language. Through the optimized prompt input block 140, the user may simply and quickly input further design requirements of the audio link by the optimized prompt. The optimized prompt input block 140 includes a submission object 141. The submission object 141 is used to receive a submission request from a user to submit the optimized prompt input by the user. The audio link archive generated above is optimized based on the optimized prompt (for example, “Add spatial audio”) input by the user using the generative AI algorithm to generate an optimized audio link archive. The optimized audio link archive is automatically loaded and executed by the process design software. The process project option 150 is used to receive the user's selection and switch between multiple process projects established through the user interface 100 such that the user may easily switch between different process projects. For example, a process project option 150a is for switching to the previous process project, and a process project option 150b is for switching to the next process project. The user interface 100 further includes a create new process project object 160. After receiving the user's selection through the create new process project object 160, the contents of the current application option 110, the prompt input block 120 and the optimized prompt input block 140 of the user interface 100 are cleared. The user interface 100 returns to the state of the embodiment of FIG. 1. That is, the user interface 100 returns to the state without the optimized prompt input block 140 or the process project option 150. Therefore, the user may quickly create a new process project.

According to the above, the present disclosure may generate the audio link archive using the generative AI algorithm based on the application information selected by the user and the prompt inputted by the user and then may automatically load and execute the audio link archive by the process design software. The user (such as a developer) does not need to manually drag objects or establish relationships between objects, nor does the user need to manually enter the design parameters of objects. The user may use the electronic device and the audio signal link design method of the present disclosure to quickly generate an audio link archive that may be executed by the process design software. Therefore, the time and complexity of the audio link design is effectively reduced.

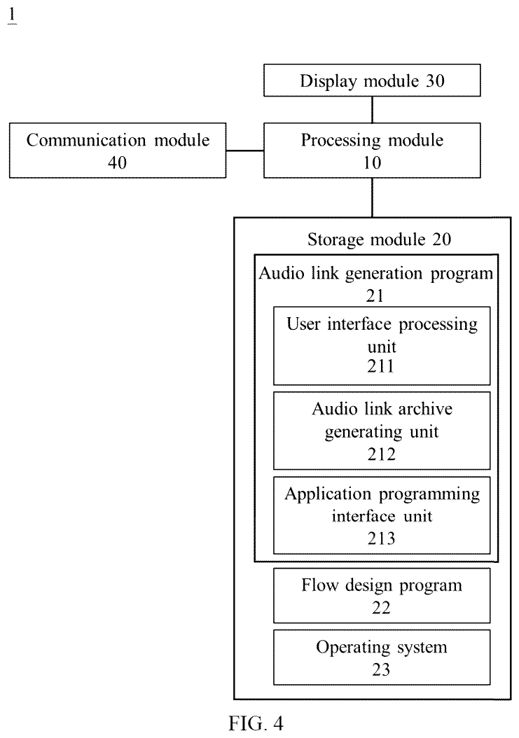

FIG. 4 is a schematic of an electronic device according to an embodiment of the present disclosure. The electronic device 1 includes a processing module 10, a storage module 20, a display module 30 and a communication module 40. The processing module 10 is electrically connected to the storage module 20, the display module 30 and the communication module 40. The electronic device 1 is, for example, a notebook computer, a desktop computer, or a tablet computer, but the present disclosure is not limited thereto. The storage module 20 is used to store programs or software required for operations of the electronic device 1. The storage module 20 stores an audio link generation program 21, a flow design program 22 and an operating system 23 of the electronic device 1. The storage module 20 is, for example, a hard disk and/or a memory, but the present disclosure is not limited thereto. The display module 30 is used to display the display image generated by executing the audio link generation program 21, the flow design program 22 and the operating system 23. The display module 30 is, for example, a liquid crystal display, an organic light emitting diode display, or a quantum dot backlight liquid crystal display, but the present disclosure is not limited thereto. The communication module 40 is used to establish a communication connection with an external device. The communication module 40 is, for example, a communication circuit that complies with a wireless communication standard or an Ethernet standard, but the present disclosure is not limited thereto. The processing module 10 is used to execute programs or software required for the operations of the electronic device 1. The processing module 10 executes the audio link generation program 21 to operate the audio signal link design method. The processing module 10 executes the flow design program 22 to operate the process design software.

The audio link generation program 21 includes a user interface processing unit 211, an audio link archive generating unit 212 and an application programming interface unit 213. The user interface processing unit 211 is used to generate a user interface 100 (as shown in FIG. 1) and to provide display image data of the generated user interface 100 on the display module 30. The user interface processing unit 211 receives the application information and the prompt input by the user through the user interface 100. The user interface processing unit 211 generates corresponding application information based on the application option 110 selected by the user in the user interface 100. For example, the user interface processing unit 211 generates application information corresponding to the earphone 110a, the play 110b and the basic 110c based on the application options 110 selected by the user in the user interface 100. The user interface processing unit 211 receives the prompt (e.g., “A portable Bluetooth speaker”) inputted by the user in the prompt input block 120. The user interface processing unit 211 receives the process project generating request from the user when the user selects the option to generate a process project object 130 in the user interface 100. After receiving the process project generating request from the user, the user interface processing unit 211 provides the application information and the prompt to the audio link archive generating unit 212. After the user interface processing unit 211 provides the application information and the prompt to the audio link archive generating unit 212, the user interface 100 is changed (for example, from the embodiment of FIG. 1 to the embodiment of FIG. 2). The user interface processing unit 211 generates the user interface 100 including the optimized prompt input block 140 and the process project option 150. The user interface processing unit 211 receives the optimized prompt (e.g., “Add spatial audio”) inputted by the user in the optimized prompt input block 140. The user interface processing unit 211 receives the user's submission request when the user selects the submission object 141 in the user interface 100. After receiving the user's submission request, the user interface processing unit 211 provides the optimized prompt to the audio link archive generating unit 212. The user interface processing unit 211 receives the user's request to create a new process project when the user selects the create new process project object 160 in the user interface 100. After receiving the user's request to create a new process project, the user interface processing unit 211 clears the contents of the current application option 110, prompt input block 120 and optimized prompt input block 140 of the user interface 100. The user interface processing unit 211 then changes the user interface 100 to return to the state of the user interface 100 of the embodiment shown in FIG. 1.

The audio link archive generating unit 212 is used to receive the application information and prompt from the user interface processing unit 211. The audio link archive generating unit 212 generates the audio link archive based on the application information and the prompt. The audio link archive generating unit 212 may be implemented by the generative AI algorithm. The generative AI algorithm is, for example, a large language model (LLM). The generative AI algorithm is trained using a large amount of known audio link archive data. The known audio link archive is defined by at least one of the aforementioned application options and includes the metadata of the process design software. In one embodiment, an audio performance index of the audio link archive generated by the audio link archive generating unit 212 may also be provided for training the generative AI algorithm. The generative AI algorithm generates the audio link archive through a retrieval augmented generation (RAG) model. Thus, the audio link archive generating unit 212 may generate the audio link archive based on the received application information and the prompt. In addition, since the audio link archive includes the metadata of the process design software, the audio link archive may be directly executed by the process design software. The audio link archive generating unit 212 receives the optimized prompt from the user interface processing unit 211, and based on the optimized prompt, the audio link archive generating unit 212 further optimizes the audio link archive generated based on the application information and the prompt to generate the optimized audio link archive. The audio link archive generating unit 212 is used to provide the audio link archive and the optimized audio link archive to the application programming interface unit 213. The application programming interface unit 213 is an application programming interface (API) between the audio link generation program 21 and the flow design program 22. After receiving the audio link archive or the optimized audio link archive, the application programming interface unit 213 provides the audio link archive or the optimized audio link archive to the process design software. Thereby, the audio link archive or the optimized audio link archive is automatically loaded and executed by the process design software. The user does not need to manually launch the process design software to load and execute the audio link archive or optimized audio link archive. Thus, the convenience of executing the audio link archive is improved. In one embodiment, the process design software performs an analysis of the audio performance index on the audio link archive or the optimized audio link archive for training the generative AI algorithm based on the audio performance index corresponding to the audio link archive or the optimized audio link archive.

Therefore, the electronic device proposed in the present disclosure may generate the audio link archive based on the application information and the prompt using the generative AI algorithm, and the audio link archive may be automatically loaded and executed by the process design software. The user does not need to manually drag objects or establish relationships between objects of the process design software for designing the audio link, nor does the user need to manually enter the design parameters of the objects of the process design software. The user may quickly generate an audio link archive that may be executed by the process design software by using the electronic device and the audio signal link design method proposed in the present disclosure. The time and complexity of the audio link design are effectively reduced.

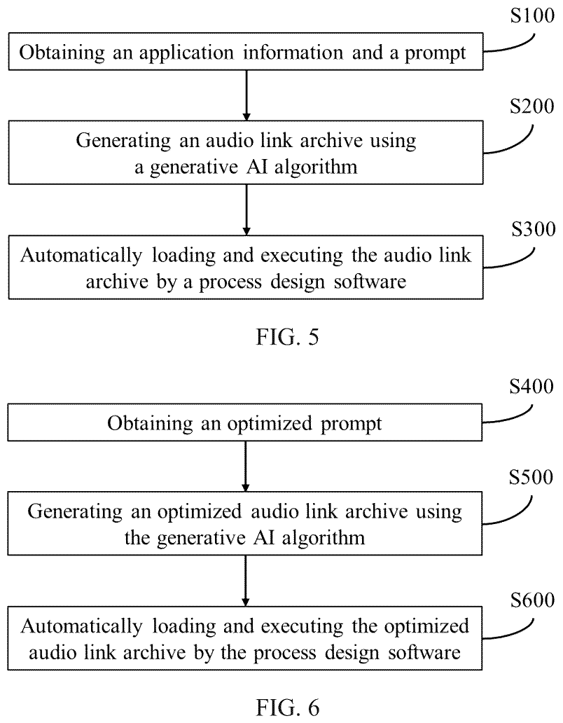

FIG. 5 is a schematic of an audio signal design method according to an embodiment of the present disclosure. The audio signal link design method includes steps S100, S200, and S300.

In step S100, the electronic device 1 obtains the application information and the prompt. The user may select the application option 110 in the user interface 100 displayed by the electronic device 1 and input the prompt. The user interface processing unit 211 of the audio link generation program 21 obtains the application information corresponding to the application option 110 and the prompt through the user interface 100. The user interface processing unit 211 provides the application information and the prompt to the audio link archive generating unit 212. In step S200, the audio link archive is generated using the generative AI algorithm. The audio link archive generating unit 212 receives the application information and the prompt from the user interface processing unit 211 to generate the audio link archive. The audio link archive contains the metadata of the process design software. The audio link archive generating unit 212 provides the audio link archive to the application programming interface unit 213. In step S300, the application programming interface unit 213 provides the audio link archive to the process design software for allowing the process design software to load and execute the audio link archive. Therefore, the user does not need to manually launch the process design software to load and execute the audio link archive.

FIG. 6 is a schematic of an audio signal design method according to another embodiment of the present disclosure. The audio signal link design method further includes steps S400, S500, and S600.

The process proceeds to step S400 after step S300. In step S400, the user interface processing unit 211 of the audio link generation program 21 obtains the optimized prompt through the user interface 100. The user interface processing unit 211 provides the optimized prompt to the audio link archive generating unit 212. In step S500, the optimized audio link archive is generated using the generative AI algorithm. The audio link archive generating unit 212 receives the optimized prompt from the user interface processing unit 211, further optimizes the audio link archive generated in step S200 with the optimized prompt and generates the optimized audio link archive. The audio link archive generating unit 212 provides the optimized audio link archive to the application programming interface unit 213. In step S600, the application programming interface unit 213 provides the optimized audio link archive to the process design software for allowing the process design software to load and execute the optimized audio link archive.

According to the above, the electronic device and audio signal link design method proposed in the present disclosure may generate an audio link archive based on application information and prompts using a generative AI algorithm and then may automatically load and execute the audio link archive using a process design software. The method of the present disclosure allows developers to quickly generate audio link archives that may be executed by the process design software without manually dragging objects, establishing relationships between objects, or manually entering object design parameters. The time and complexity of audio link design are effectively reduced.

It is to be understood that the term “comprises”, “comprising”, or any other variants thereof is intended to encompass a non-exclusive inclusion, such that a process, method, article, or device of a series of elements not only includes those elements but also comprises other elements that are not explicitly listed, or elements that are inherent to such a process, method, article, or device. An element defined by the phrase “comprising a . . . ” does not exclude the presence of the same element in the process, method, article, or device that comprises the element.

Although the present invention has been explained in relation to its preferred embodiments, the explanation is not intended to limit the present invention. It will be apparent to those skilled in the art with regard to the present invention that other modifications of the exemplary embodiments beyond those embodiments specifically described here may be made without departing from the spirit of the invention. Accordingly, such modifications are considered within the scope of the invention as limited solely by the appended claims.

What is claimed is:

1. An audio signal link design method, comprising:
obtaining, through a user interface, an application information and a prompt;
generating, based on the application information and the prompt, an audio link archive using a generative artificial intelligence (AI) algorithm; and
automatically loading and executing the audio link archive by a process design software.

2. The audio signal link design method as claimed in claim 1, wherein the audio signal link design method further comprises:
obtaining an optimized prompt;
generating an optimized audio link archive using the generative AI algorithm, based on the optimized prompt and the audio link archive; and
automatically loading and executing the optimized audio link archive by the process design software.

3. The audio signal link design method as claimed in claim 1, wherein the generative AI algorithm is a large language model.

4. The audio signal link design method as claimed in claim 1, wherein the generative AI algorithm generates the audio link archive through a retrieval augmented generation model.

5. The audio signal link design method as claimed in claim 1, wherein the prompt is a language text.

6. The audio signal link design method as claimed in claim 1, wherein the application information is a preset application option.

7. The audio signal link design method as claimed in claim 1, wherein the audio link archive includes a metadata of the process design software.

8. An electronic device, comprising:
a storage module for storing an audio link generation program; and
a processing module, electrically connected to the storage module, for reading the audio link generation program for executing an audio signal link design method;
wherein the audio signal link design method comprises:
obtaining, through a user interface, an application information and a prompt;
generating, based on the application information and the prompt, an audio link archive using a generative artificial intelligence (AI) algorithm; and
automatically loading and executing the audio link archive by a process design software.
